(19) United States
(12) Patent Application Publication
(10) Pub. No.: US 2023/0388320 A1
(43) Pub. Date: Nov. 30, 2023

(54) INTRUSION DETECTION WITH ADAPTIVE PATTERN SELECTION

(71) Applicant: VMware, Inc., Palo Alto, CA (US)

(72) Inventors: Russell LU, Pleasanton, CA (US); Sirisha MYNENI, Santa Clara, CA (US); Nafisa MANDLIWALA, Santa Clara, CA (US); Mani KANCHERLA, Cupertino, CA (US)

(73) Assignee: VMware, Inc., Palo Alto, CA (US)

(21) Appl. No.: 17/752,990

(22) Filed: May 25, 2022

(51) Int. Cl. H04L 9/40; G06F 9/455

(52) U.S. Cl. CPC H04L 63/1416; H04L 63/1425; G06F 9/45558; G06F 2009/45587

(57) ABSTRACT

Example methods and systems for intrusion detection with adaptive pattern selection are described. In one example, a computer system may perform pattern selection by selecting a subset from a set of multiple patterns based on metric information. In response to receiving a packet belonging to a flow between a source endpoint and a destination endpoint, a first matching operation may be performed to determine whether the packet is matchable to a particular pattern from the set of multiple patterns or the subset. In response to determination that the packet is matchable to the particular pattern, a second matching operation may be performed to determine whether the packet is matchable to a particular signature. The metric information associated with the particular pattern may be updated based on the first matching operation and/or the second matching operation. This way, the subset may be updated based at least on the updated metric information.

### BACKGROUND

Virtualization allows the abstraction and pooling of hardware resources to support virtual machines in a Software-Defined Networking (SDN) environment, such as a Software-Defined Data Center (SDDC). For example, through server virtualization, virtualization computing instances such as virtual machines (VMs) running different operating systems may be supported by the same physical machine (e.g., referred to as a “host”). Each VM is generally provisioned with virtual resources to run an operating system and applications. The virtual resources may include central processing unit (CPU) resources, memory resources, storage resources, network resources, etc. In practice, packet communication among VMs is susceptible to security attacks by malicious third parties. It is therefore desirable to implement intrusion detection to strengthen network security.

### BRIEF DESCRIPTION OF DRAWINGS

FIG. 1 is a schematic diagram illustrating an example Software-Defined Networking (SDN) environment in which intrusion detection with adaptive pattern selection may be performed;

FIG. 2 is a schematic diagram illustrating a physical implementation view of the SDN environment in FIG. 1;

FIG. 3 is a flowchart of an example process for a computer system to perform intrusion detection with adaptive pattern selection;

FIG. 4 is a flowchart of an example detailed process for a computer system to perform intrusion detection with adaptive pattern selection;

FIG. 5 is a schematic diagram illustrating an example for generating a set of multiple patterns and selection of a subset from the set;

FIG. 6 is a schematic diagram illustrating a first example of intrusion detection with adaptive pattern selection for a first packet flow; and

FIG. 7 is a schematic diagram illustrating a second example of intrusion detection with adaptive pattern selection for a second packet flow.

### DETAILED DESCRIPTION

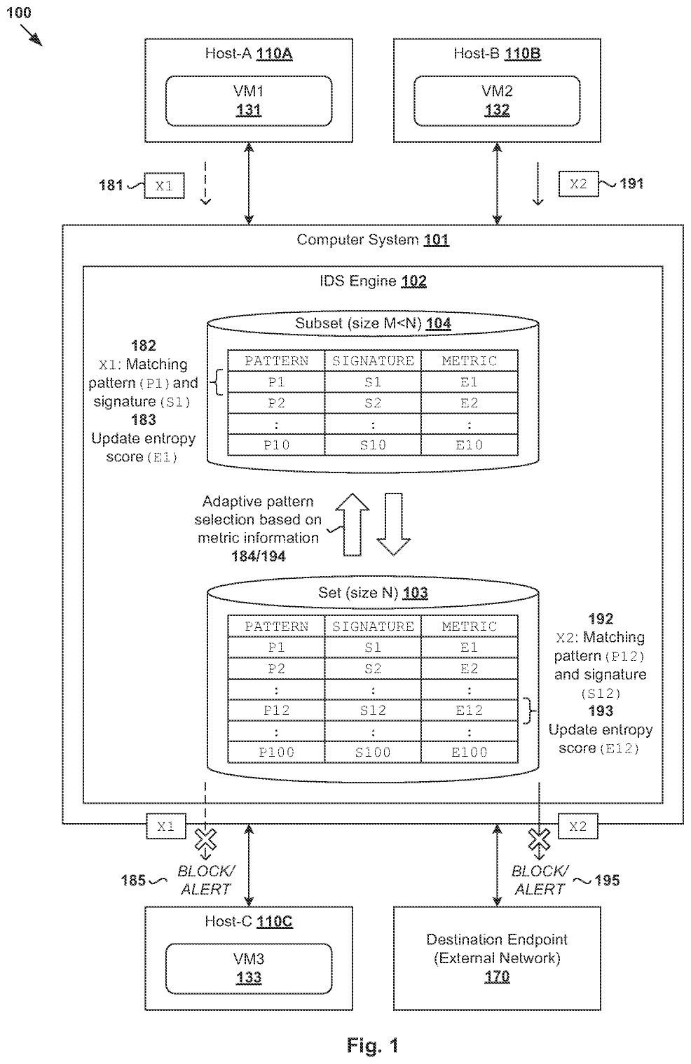

According to examples of the present disclosure, intrusion detection with adaptive pattern selection may be implemented more efficiently to strengthen network security. One example may involve a computer system (e.g., 101 in FIG. 1) selecting a subset from a set of multiple patterns associated with respective multiple signatures for intrusion detection (see 103-104 in FIG. 1). The subset may be selected based on metric information associated with the multiple patterns. In response to receiving a packet (see 181/191 in FIG. 1) belonging to a flow between a source endpoint and a destination endpoint, the computer system may perform a first matching operation to determine whether the packet is matchable to a particular pattern from the set of multiple patterns or the subset.

In response to determination that the packet is matchable to the particular pattern, a second matching operation may be performed to determine whether the packet is matchable to a particular signature associated with the particular pattern. The computer system may update the metric information associated with the particular pattern based on the first matching operation and/or the second matching operation. Adaptive pattern selection (see 184/194 in FIG. 1) may be performed by updating the subset based at least on the updated metric information. Using examples of the present disclosure, matching operations may be performed more efficiently using the subset, which is adaptable according to the nature of network traffic.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawings, can be arranged, substituted, combined, and designed in a wide variety of different configurations, all of which are explicitly contemplated herein. Although the terms “first” and “second” are used to describe various elements, these elements should not be limited by these terms. These terms are used to distinguish one element from another. For example, a first element may be referred to as a second element, and vice versa.

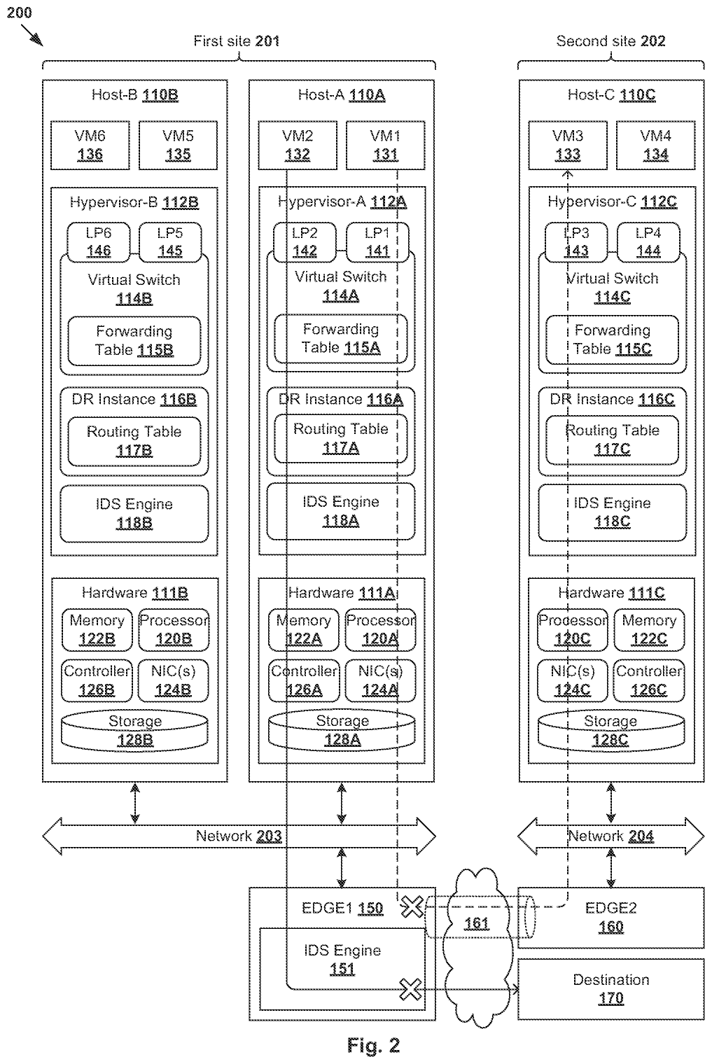

FIG. 1 is a schematic diagram illustrating example software-defined networking (SDN) environment 100 in which intrusion detection with adaptive pattern selection may be performed. FIG. 2 is a schematic diagram illustrating physical implementation view 200 of SDN environment 100 in FIG. 1. It should be understood that, depending on the desired implementation, SDN environment 100 may include additional and/or alternative components than that shown in FIG. 1 and FIG. 2, respectively. In practice, SDN environment 100 may include any number of hosts (also known as “computer systems,” “computing devices”, “host computers”, “host devices”, “physical servers”, “server systems”, “transport nodes,” etc.). Each host may be supporting any number of virtual machines (e.g., tens or hundreds).

Referring first to FIG. 1, SDN environment 100 includes multiple hosts, such as host-A 110A, host-B 110B and host-C 110C. Computer system 101 with intrusion detection system (IDS) engine 102 may be deployed along a datapath between any pair of source and destination endpoints. Each source/destination endpoint may be a virtual machine (VM) or physical machine. For example, a first packet flow is between source endpoint=VM1 131 supported by host-A 110A at a first data center site and destination endpoint=VM3 133 supported by host-B 110B at a second data center site. A second packet flow includes source endpoint=VM2 132 supported by host-B 110B and destination endpoint 170 located on an external network (e.g., Internet).

Referring also to FIG. 2, one example of computer system 101 may be EDGE1 150, which is deployed at the edge of first site 201 to facilitate cross-site communication with via EDGE2 160 located at the edge of second site 202. In practice, EDGE1 150 and EDGE2 160 may be implemented using VMs and/or physical machines (also known as “bare metal machines”). In practice, EDGE 150/160 may be configured to perform functionalities of a switch, router, bridge, gateway, edge appliance, or any combination thereof. For example, EDGE 150/160 may implement a centralized service router (SR) to provide networking services, such as gateway service, domain name system (DNS) forwarding, Internet Protocol (IP) address assignment using dynamic host configuration protocol (DHCP), source network address translation (SNAT), destination NAT (DNAT), deep packet inspection, etc. When acting as a gateway, each EDGE 150/160 provides an exit point to an external network.

Hosts 110A-C may each include any suitable hardware and virtualization software (e.g., hypervisors 112A-C) to support various VMs 131-136. At first site 201, hosts 110A-B may be connected with EDGE1 150 via any suitable physical network 203. At second site 202, host-C 110C may be connected with EDGE2 160 via physical network 204. As such, a VM at first site 201 (e.g., VM1 131) may communicate with another VM (e.g., VM3 133) at second site 202 via EDGE1 150 and EDGE2 160. For each host 110A/110B/110C, hypervisor 112A/112B/112C maintains a mapping between underlying hardware 111A/111B/111C and virtual resources allocated to the VMs.

Hardware 111A/111B/111C includes various physical components, such as central processor(s) or processor(s) 120A/120B/120C; memory 122A/122B/122C; physical network interface controllers (NICs) 124A/124B/124C; and storage disk(s) 128A/128B/128C accessible via storage controller(s) 126A/126B/126C, etc. Virtual resources are allocated to each virtual machine to support a guest operating system (OS) and applications, such as virtual central processor (CPU), guest physical memory, virtual disk(s) and virtual network interface controller (VNIC). Hypervisor 112A/112B/112C further implements virtual switch 114A/114B/114C and logical distributed router (DR) instance 116A/116B/116C to handle egress packets from, and ingress packets to, respective VMs.

In practice, logical switches and logical distributed routers may be implemented in a distributed manner and can span multiple hosts 110A-C to connect the VMs. For example, a logical switch may be configured to provide logical layer-2 connectivity to VMs supported by different hosts. The logical switch may be implemented collectively by virtual switches 114A-C of respective hosts 110A-C and represented internally using forwarding tables (e.g., 115A-C) at the respective virtual switches 114A-C. Further, logical distributed routers that provide logical layer-3 connectivity may be implemented collectively by distributed router (DR) instances (e.g., 116A-C) of respective hosts 110A-C and represented internally using routing tables (e.g., 117A-C) at the respective DR instances. Routing tables 117A-C may be each include entries that collectively implement the respective logical distributed routers.

VMs 131-136 may send and receive packets via respective logical ports 141-146. As used herein, the term “logical port” may refer generally to a port on a logical switch to which a virtualized computing instance is connected. A “logical switch” may refer generally to an SDN construct that is collectively implemented by virtual switches of hosts 110A-C, whereas a “virtual switch” (e.g., 114A-C) may refer generally to a software switch or software implementation of a physical switch. In practice, there is usually a one-to-one mapping between a logical port on a logical switch and a virtual port on a virtual switch. However, the mapping may change in some scenarios, such as when the logical port is mapped to a different virtual port on a different virtual switch after migration of the corresponding virtualized computing instance (e.g., when the source and destination hosts do not have a distributed virtual switch spanning them).

Although examples of the present disclosure refer to virtual machines, it should be understood that a “virtual machine” running on a host is merely one example of a “virtualized computing instance” or “workload.” A virtualized computing instance may represent an addressable data compute node or isolated user space instance. In practice, any suitable technology may be used to provide isolated user space instances, not just hardware virtualization. Other virtualized computing instances may include containers (e.g., running within a VM or on top of a host operating system without the need for a hypervisor or separate operating system or implemented as an operating system level virtualization), virtual private servers, client computers, etc. Such container technology is available from, among others, Docker, Inc. The virtual machines may also be complete computational environments, containing virtual equivalents of the hardware and software components of a physical computing system.

As used herein, the term “hypervisor” may refer generally to a software layer or component that supports the execution of multiple virtualized computing instances, including system-level software in guest virtual machines that supports namespace containers such as Docker, etc. Hypervisors 114A-C may each implement any suitable virtualization technology, such as VMware ESX® or ESXi™(available from VMware, Inc.), Kernel-based Virtual Machine (KVM), etc. The term “packet” may refer generally to a group of bits that can be transported together from a source to a destination, such as message, segment, datagram, etc. The term “traffic” may refer generally to a flow of packets. The term “layer 2” may refer generally to a Media Access Control (MAC) layer; “layer 3” to a network or IP layer; and “layer-4” to a transport layer (e.g., using transmission control protocol (TCP) or user datagram protocol (UDP)) in the Open System Interconnection (OSI) model, although the concepts described herein may be used with other networking models.

In practice, tunnel 161 may be established between EDGE1 150 and EDGE2 160 using any suitable tunneling protocol. For example, a Virtual Private Network (VPN) based on Internet Protocol Security (IPSec) may bridge traffic in a hybrid cloud environment between first site 201 (e.g., on-prem data center) and second site 202 (e.g., public cloud environment). In practice, IPSec is a secure network protocol suite that provides data authentication, integrity and confidentiality between a pair of entities (e.g., data centers, gateways) across an IP-based network. One example in the IPSec protocol suite is Encapsulating Security Payload (ESP), which provides origin authenticity using source authentication, data integrity and confidentiality through encryption protection for IP packets. Another example protocol is Authentication Header (AH) that also ensures source authentication and data integrity.

One of the challenges in SDN environment 100 is improving the overall data center security. To protect VMs 131-136 against security threats caused by malicious packets, computer system 101 may be configured to support an intrusion detection system (IDS) engine 102 to perform, inter alia, signature-based IDS. Malicious packets may be detected by matching packets against a set of signatures associated with security attacks. In practice, however, such matching operations are generally time-consuming and resource-intensive in terms of CPU time and power. As new security attacks are discovered, the number of signatures and associated patterns to be matched increases, which exacerbates the resource consumption issue. It is therefore desirable to improve the efficiency of intrusion detection.

### Intrusion Detection With Adaptive Pattern Selection

According to examples of the present disclosure, intrusion detection with adaptive pattern selection may be implemented to improve intrusion detection efficiency and strengthen data center security in SDN environment 100. Instead of matching each and every packet to a set of multiple (N) patterns associated with respective multiple signatures, matching operations may also be performed using a subset with size M<N patterns to improve efficiency. The subset may be selected from the set based on metric information associated with the multiple patterns. As the metric information is updated based on results of real-time matching operations, adaptive pattern selection may be performed to update the subset dynamically.

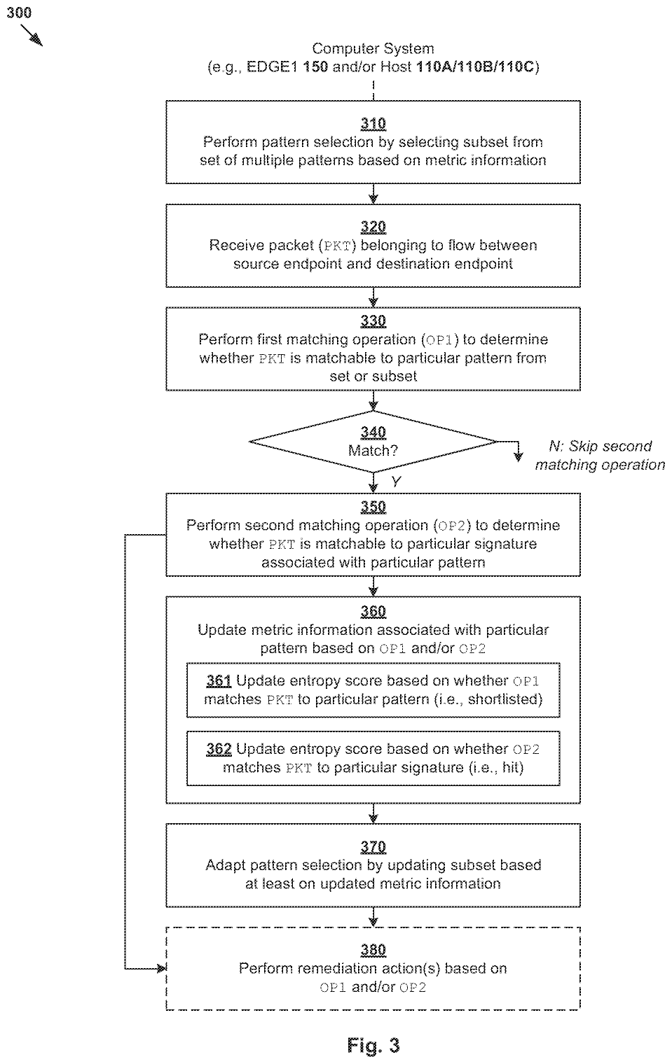

In the following, any suitable computer system 101 with IDS engine 102 may be deployed to implement examples of the present disclosure, such as EDGE1 150 with IDS engine 151, host 110A/110B/110C with IDS engine 118A/118B/118C, EDGE2 160 with IDS engine (not shown for simplicity), any computer system that is deployed along a datapath between a source endpoint and a destination endpoint, etc. Computer system 101 may further include datastore(s) to store the pattern set and subset. In more detail, FIG. 3 is a flowchart of example process 300 for a computer system to perform intrusion detection with adaptive pattern selection. Example process 300 may include one or more operations, functions, or actions illustrated by one or more blocks, such as 310 to 380. The various blocks may be combined into fewer blocks, divided into additional blocks, and/or eliminated depending on the desired implementation.

At 310 in FIG. 3, pattern selection may be performed by selecting a subset (see 104 in FIG. 1) from a set of multiple patterns (see 103 in FIG. 1) associated with respective multiple signatures for intrusion detection. For example, set 103 may include N patterns, while subset 104 may include M<N patterns that are selected based on metric information associated with the multiple patterns. For simplicity, various examples will be discussed below using N=100 patterns in set 103, and M=10 patterns in subset 102. It should be understood that there may be tens of thousands of patterns and associated signatures in set 103 in practice.

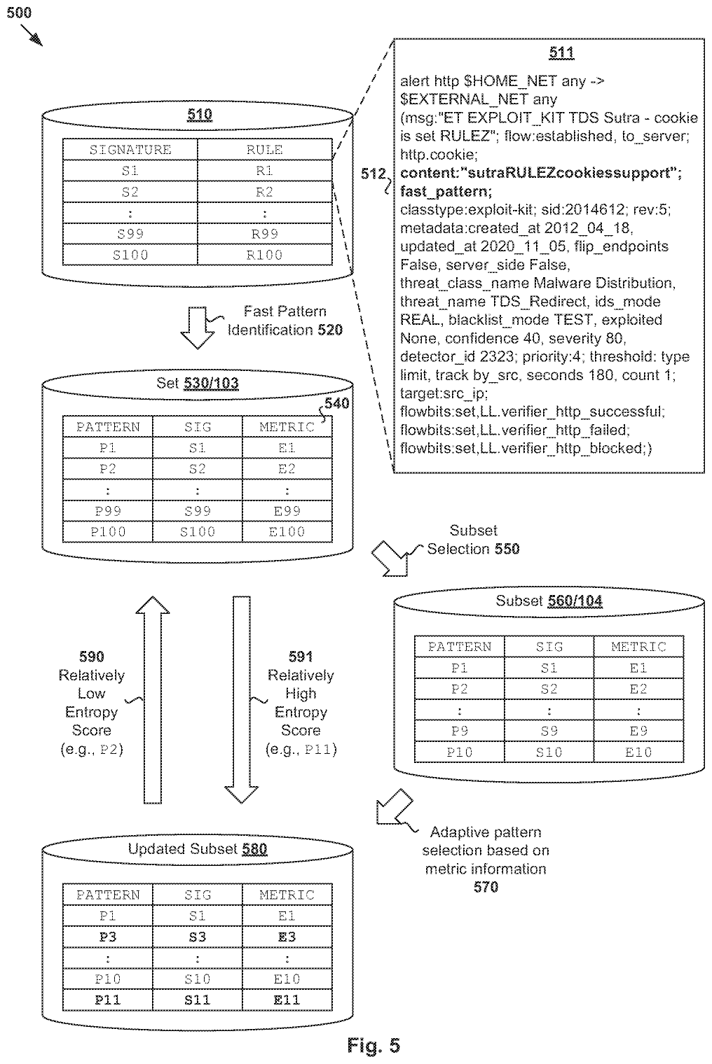

As used herein, the term “pattern” may refer generally to a feature or characteristic associated with a signature. Using signature-based intrusion detection, a signature may be defined or expressed using a signature rule according to any suitable syntax, such as based on Snort, Suricata, etc. In this case, a pattern may be expressed using any suitable string that is detectable from a malicious packet, such as a sequence of byte(s) and/or text character(s), etc. Some examples will be discussed using FIGS. 5.

At 320 and 330 in FIG. 3, in response to receiving a packet belonging to a flow between a source endpoint and a destination endpoint, a first matching operation may be performed to determine whether the packet is matchable to a particular pattern from set 103 or subset 104. At 340 and 350, in response to determination that the packet is matchable to the particular pattern, a second matching operation may be performed to determine whether the packet is matchable to a particular signature associated with the particular pattern.

Depending on the desired implementation, set 103 and subset 104 may include “fast patterns” to improve matching efficiency. In the example in FIG. 1, consider signature=S1 that is associated with multiple patterns (e.g., P1, P1a, . . . , P1k) from which fast pattern=P1 is selected to be a representative pattern of (e.g., unique to) signature=S1. This way, instead of matching a packet to each and every pattern of a signature, a two-stage matching process may be performed. For example in FIG. 1, the “first matching operation” at block 330 may be a fast pattern matching operation to match first packet 181 to a particular fast pattern (e.g., P1). If there is a match, the “second matching operation” at block 350 may be a slow-path matching operation to determine whether the packet matches with additional pattern(s) of an associated signature (e.g., S1). See 181-182 in FIG. 1.

In another example in FIG. 1, consider second packet (X2) 191 from VM2 132 to external destination endpoint 170, and fast pattern=P12 is associated with signature=S12. Similarly, the “first matching operation” at block 330 may be a fast pattern matching operation to match packet 191 to fast pattern=P12. If there is a match, the “second matching operation” at block 350 may be a slow-path matching operation for determining whether packet 191 matches with additional pattern(s) of signature=S12. See 191-192 in FIG. 1.

At 360 in FIG. 3, metric information associated with the particular pattern may be updated based on the first matching operation and/or the second matching operation. This way, at 370, adaptive pattern selection may be performed by updating the subset based at least on the updated metric information associated with the particular pattern. Here, the term “metric information” may be any suitable information that is indicative of the relevance and/or effectiveness of a pattern for intrusion detection. As will be discussed below, the metric information may be in the form of an entropy score that is calculated based on (a) the number of times a particular pattern is shortlisted for the second matching operation, and (b) the number of times the particular signature is a hit based on the second matching operation.

For example in FIG. 1, each pattern in set 103 and subset 104 may be associated with an entropy score. In this case, for first packet (X1) 181, block 360 may involve updating entropy score=E1 based on (a) whether the first matching operation matches packet 181 to pattern=P1 and shortlists signature=S1 for the second matching operation; and/or (b) whether the second matching operation matches packet 181 to signature=S1 (i.e., signature hit). For second packet (X2) 182, block 360 may involve updating entropy score=E12 associated with pattern=P12 in a similar manner. This way, as the metric information is updated, subset 104 may be updated by removing patterns from subset 104, and/or adding patterns from set 103. See 183-184 and 193-194 in FIG. 1.

At 370 in FIG. 3, any suitable user-configurable remediation action(s) may be performed based on the first and/or the second matching operations. For example, in response to detecting a signature hit (i.e., packet matches with additional pattern(s) of the signature during the second matching operation), one or more of the following remediation actions may be performed: blocking or dropping the packet, generating and sending an alert to a user (e.g., network administrator), generating log information, etc. See 185/195 in FIG. 1.

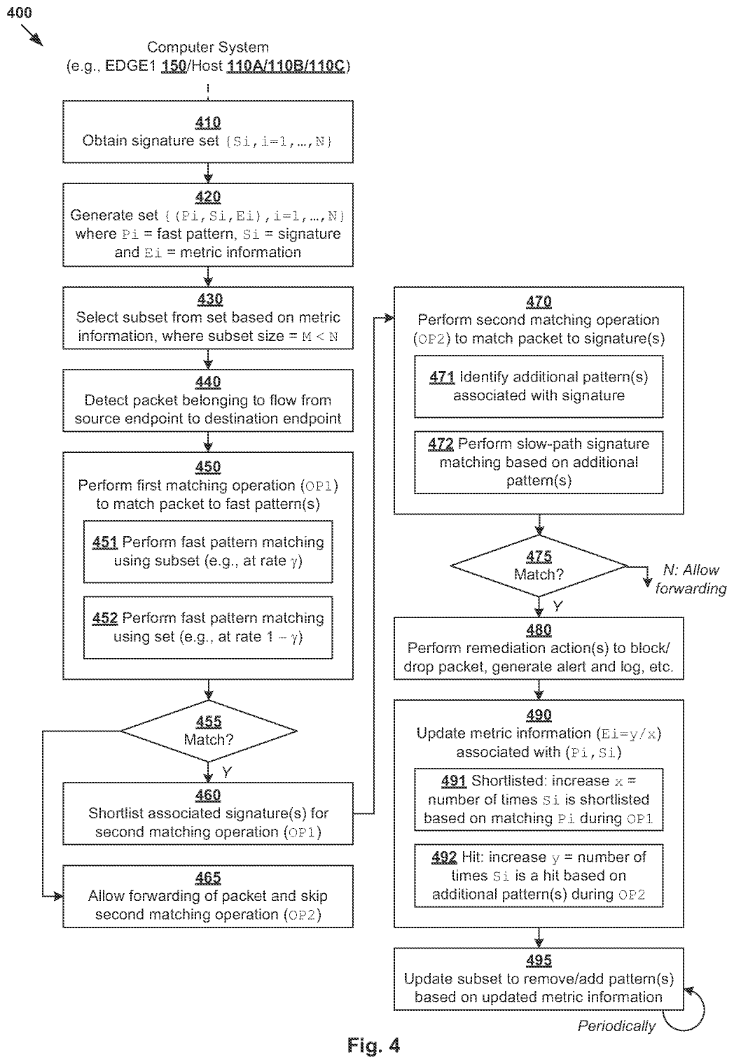

Using examples of the present disclosure, subset 104 may be updated based on metric information that is dynamically updated based on results of matching operations and the nature of network traffic traversing computer system 101. Over time, the most relevant/effective patterns may be included in subset 104 to facilitate faster matching and improve the efficiency of IDS engine 102. Further, examples of the present disclosure may be implemented to ensure that IDS engine 102 is not bogged down by some malicious actors, such as those who try to craft traffic to overwhelm IDS engine 102 by reverse engineering and crafting traffic that causes IDS engine 102 to spend more time processing flows that are inconsequential. In practice, any suitable safeguard(s) may be implemented to stop or reduce the frequency of such alerts, such as thresholding the number of alerts generated within a period of time, etc. Various examples will be discussed below using FIGS. 4-7.

### Set and Subset of Multiple Patterns

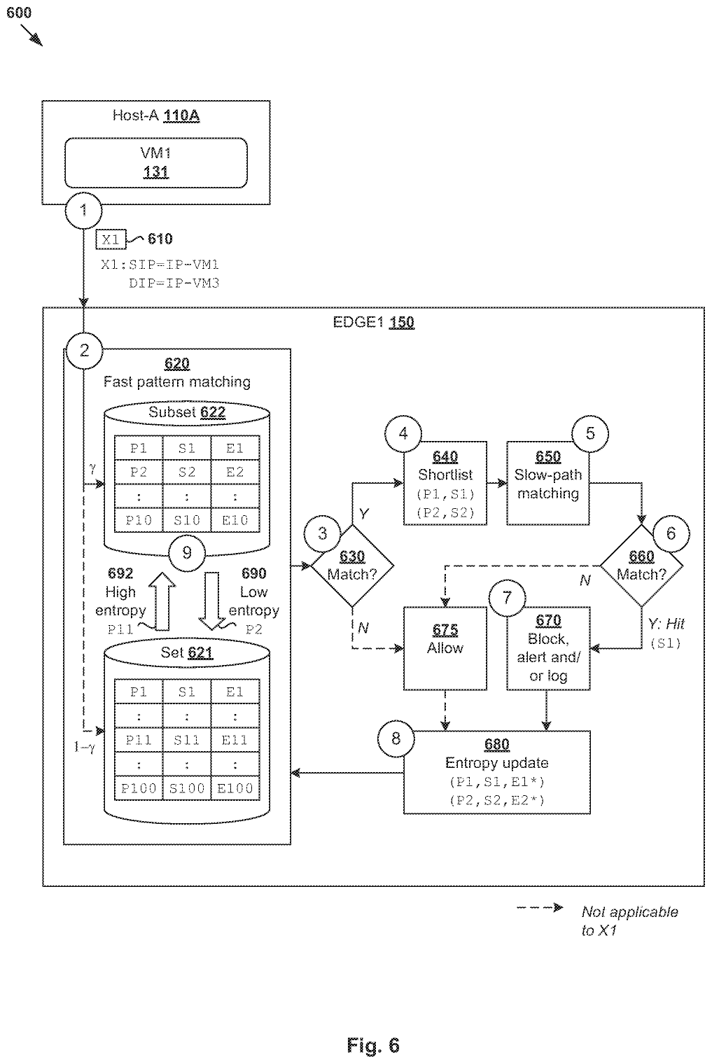

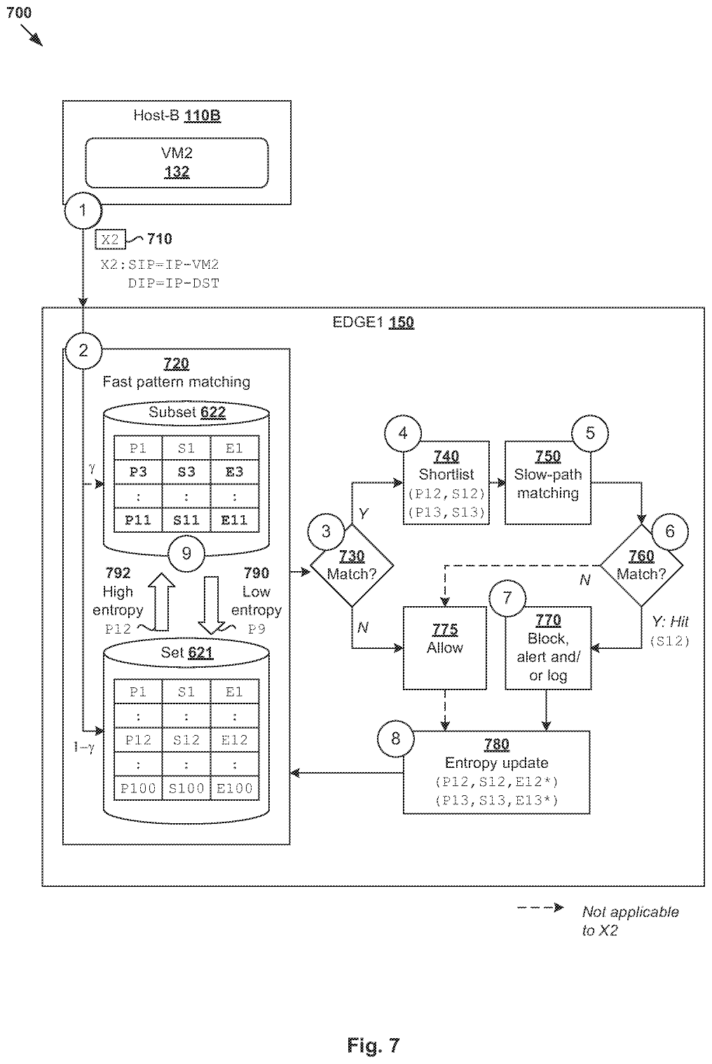

FIG. 4 is a flowchart of example detailed process 400 for a computer system to perform intrusion detection with adaptive pattern selection. Example process 400 may include one or more operations, functions, or actions illustrated by one or more blocks, such as 410 to 495. Depending on the desired implementation, various blocks may be combined into fewer blocks, divided into additional blocks, and/or eliminated. Blocks 410-430 in FIG. 4 will be explained using FIG. 5, which is a schematic diagram illustrating example 500 for generating a set of multiple patterns and selection of a subset from the set. Blocks 440-495 will be explained using FIGS. 6-7.

### (a) Signature Set

At 410 in FIG. 4, a set of multiple (N) signatures denoted as {Si, i=1, . . . , N} may be obtained for signature-based IDS. Here, the term “obtain” may refer generally to a computer system retrieving or receiving the signature set from any suitable source, such as another computer system, datastore, etc. In practice, each signature (Si) may be defined using any suitable signature rule, such as based on Snort or Suricata rule syntax, etc. Signature rules are usually generated from previously-discovered malicious packets, but they may be configured to match any type of packets.

For example, at 510 in FIG. 5, consider an example signature rule (see R1 511) specifying multiple patterns associated with signature=S1. Signature rule 511 may include an action (e.g., “alert”) in response to a match, protocol (e.g., “http”), source information (e.g., “$HOME_NET any”), direction (e.g., “->” indicating from source to destination), destination information (e.g., “$EXTERNAL_NET any”), parameters (e.g., “msg: ET EXPLOIT_KIT . . . ”) and content (e.g., “sutraRULEZcookiesupport”). Signature rule 511 may include any suitable keywords, such as classtype to categorize the rule, rev to identify revisions of the rule, priority level, flowbits (e.g., “flowbits:set, LL.verifier_http_successful,” “flowbits: set,LL.verifier_http_failed,” and “flowbits: set,LL.verifier_http_blocked”) to track states during a transport protocol session, etc.

The action specified by each rule dictates what the rule does once all patterns specified by the rule are met (also known as rule conditions). For example, action=“alert” may be defined to generate an alert using any suitable alert method and log information identifying the offending packet. Other example actions may include log (i.e., only logs the offending packet), pass (i.e., ignores the packet) and drop (i.e., drops the offending packet and logs it).

### (b) Set of Multiple Patterns

At 420 in FIG. 4, fast pattern identification may be performed to identify a set of representative “fast” patterns associated with the signature set. The set of multiple (N) fast patterns associated with respective signatures may be denoted as {(Pi, Si) for i=1, . . . , N}, where Si=signature and Pi=fast pattern associated with Si. For example in FIG. 5, fast pattern identification may be performed to generate a set of N=100 fast patterns (see 520-530).

In practice, fast pattern identification may be performed statically or dynamically using any suitable algorithm(s). Using a static approach for example, fast pattern identification may involve parsing each signature rule to identify a “fast_pattern” keyword. Content of the “fast_pattern” keyword is usually defined by signature definition/rule writer(s), etc. For example in FIG. 5, signature rule 511 for S1 may be parsed to identify a “fast_pattern” keyword that appears after a “content” keyword (see 512). Alternatively and/or additionally, a more dynamic approach may be implemented instead of relying on the “fast_pattern” keyword.

One purpose of fast pattern identification is to improve matching efficiency and reduce the number of signatures that need be evaluated in full, especially for a large signature set (e.g., N=15,000). Instead of matching a packet to multiple patterns of each signature in signature set 510, a multi-stage matching process may be performed to improve efficiency. In this case, a first matching operation may be performed to determine whether a packet is matchable to the content of a “fast_pattern” keyword (denoted as P1 for S1). If yes (i.e., fast pattern matched), a second matching operation may be performed to determine whether the packet is matchable to additional patterns of a signature (e.g., S1) based on content of other keywords. Otherwise (i.e., fast pattern not matched), the second matching operation may be skipped. A signature hit only occurs when all patterns of a signature are matched.

### (c) Subset Selection

At 430 in FIG. 4, subset selection may be performed based on metric information (Ei) associated with (Pi, Si), where i=1, . . . , N. The size of subset 560 may be denoted as M (e.g., M=10), where M<N and N=size of set 530 (e.g., N=100). In the example in FIG. 5, metric information 540 may be in the form of a relative entropy score (Ei) associated with each fast pattern (Pi) in set 530. Any suitable metric information 540 may be calculated based on matching operation results to indicate the relevance or effectiveness of an associated fast pattern (Pi) according to real-time network traffic conditions. For example, a relatively high entropy score may indicate that one pattern (e.g., E1=0.5 for P1) is more relevant or effective for intrusion detection compared to another pattern (e.g., E100=0.1 for P100) with a relatively low entropy score. As such, at a high level, subset 560 may represent a cache of the most relevant or effective patterns, which facilitates faster matching.

As pattern matching is performed to match packets to fast pattern(s) and associated signature(s) in set 530 or subset 560, metric information associated with the fast pattern(s) may be updated. One example to calculate or update an entropy score (Ei) is expressed below:

$$Ei ( Pi , Si ) = \frac{y}{x} .$$

In the above, denominator x=number of times a particular signature (Si) is shortlisted during a first matching operation (e.g., fast pattern matching) for a second matching operation (e.g., slow-path matching). The particular signature (Si) may be shortlisted in response to matching a packet with associated fast pattern (Pi) during the first matching operation. Numerator y=number of times the particular signature (Si) is found to be a hit during slow-path matching.

### (d) Adaptive Pattern Selection

At 440-495 in FIG. 4, adaptive pattern selection may be performed to update the subset as metric information is updated based on the first and/or second matching operations. For example in FIG. 5, an updated subset may be generated as metric information (Ei) is updated (see 570-580). In a first example (see 590), fast pattern=P2 associated with a relatively low entropy score=E2 may be removed from subset 580. In a second example (see 591), fast pattern=F11 associated with a relatively high entropy score may be added to subset 580 from set 530. This way, the most relevant/effective fast patterns may be included in subset 580 as the nature of network traffic and malicious attacks change over time.

Blocks 440-495 will be discussed further below using FIGS. 6-7. The examples will be discussed using IDS engine 151 on EDGE1 150 to implement intrusion detection with adaptive pattern selection according to examples of the present disclosure. Alternatively or additionally, adaptive pattern selection may be implemented by one or more of the following: IDS engine 118A on source host-A 110A, IDS engine (not shown for simplicity) on EDGE2 160 and IDS engine 118C on destination host-C 110C. Set 530 and subset 560/580 may be stored in any suitable datastore(s).

### First Packet Flow

FIG. 6 is a schematic diagram illustrating first example 600 of intrusion detection with adaptive pattern selection for a first packet flow. In this example, consider a packet flow between source=VM1 131 and destination=VM3 133 via EDGE1 150 and EDGE2 160 located at respective sites 201-202.

At 610-620 in FIG. 6, in response to detecting a packet (see X1 610) belonging to a first packet flow between source=VM1 131 and destination=VM3 133, EDGE1 150 may perform fast pattern matching (i.e., first matching operation) using either set 621 or subset 622 that is selected from set 621. Similar to the example in FIG. 5, there are N=100 fast patterns in set 621 and M=10 (i.e., M<N) fast patterns in subset 622. See 440-450 in FIG. 4.

In practice, fast pattern matching may be performed using subset 622 or set 621. For example, any suitable sampling rate (denoted γ) may be set such that packets are matched to subset 622 at a rate of γ, or set 621 at a rate of (1−γ). Using γ=0.7 for example, fast pattern matching will be performed using subset 622 for 70% of packets, while set 621 is used for the remaining (i.e., 30%). Ideally, in a stable system, subset 622 would be substantially stable with relatively few signature/pattern addition(s) or deletion(s), and most packets would be matched to subset 622. Although it is more efficient to use subset 622 because of the fewer patterns, pattern matching using set 621 allows metric information associated with other patterns (i.e., those not in subset 622) to be updated over time according to changing traffic patterns in SDN environment 100. In practice, the sampling rate (γ) may be adjusted automatically by the IDS engine between a minimum value (e.g., 0.5) and a maximum value (e.g., 0.9) based on any suitable factor(s), such as how stable subset 622 is over some unit of time or amount of traffic processed, etc. In the example in FIG. 6, subset 622 will be used for fast pattern matching. See also 451-452 in FIG. 4.

Depending on the desired implementation, fast pattern matching may involve inspecting any suitable packet flow information associated the packet, such as header and/or payload information. Example packet flow information may include tuple information specified by the packet such as source IP address, destination IP address, source port number, destination port number, protocol, or any combination thereof. Alternatively or additionally, fast pattern matching may involve inspecting context information associated with the packet, such as information associated with an application, process or VM from which the packet originates; information derivable from the packet; information associated with client device operated by a user, etc.

At 630-640 in FIG. 6, in response to determination that there is a match in subset 622 during fast pattern matching, EDGE1 150 may add the matching (Pi, Si) in a shortlist for slow-path matching. Otherwise (i.e., no matching fast pattern), EDGE1 150 may allow forwarding of the packet towards the destination endpoint while skipping slow-path matching. In the example in FIG. 6, multiple fast patterns in subset 622 may be matched to X1 610, including first fast pattern=P1 associated with first signature=S1, and second fast pattern=P2 associated with second signature=S2. See also 455-465 in FIG. 4.

At 650 in FIG. 6, EDGE1 150 may perform slow-path matching to determine whether X1 610 is matchable to a signature associated with each matching fast pattern in the shortlist. Slow-path matching may involve (1) identifying additional pattern(s) associated with the signature based on signature rule information, and (2) determining whether the packet is matchable to the additional pattern(s). For example, once X1 610 is matched to fast pattern=P1, additional pattern(s) of signature=S1 may be identified from its signature rule (see 511 in FIG. 5) based on content of other keywords. Slow-path matching may be repeated for signature=S2 associated with fast pattern=P2. See also 470-472 in FIG. 4.

At 660-670 in FIG. 6, in response to determination that there is a matching signature based on the additional pattern(s) during slow-path matching, EDGE1 150 may perform any suitable remediation action(s), such as blocking or dropping X1 610, generating and sending an alert to a user (e.g., network administrator), generating log information, etc. Otherwise, at 675, EDGE1 150 may allow X1 610 to be forwarded towards destination=VM3 133. See also 480 in FIG. 4.

At 680 in FIG. 6, EDGE1 150 may update the metric information associated matching fast patterns P1 and P2, such as using y/x discussed using FIG. 5. Consider the case where E1=E2=0.5 based on (x=10, y=5) for both P1 and P2. Since P1 is a match during fast pattern matching and signature=S1 is a match during slow-path matching (i.e., both shortlisted and hit), E1 may be updated from 0.5 to (y+1)/(x+1)=6/11=0.55. In contrast, P2 is a match during fast pattern matching but signature=S2 is a not a match during slow-path matching (i.e., shortlisted but no hit), E2 may be updated from 0.5 to (y+0)/(x+1)=5/11=0.45. In other words, the entropy score of P1 increases from E1=0.5 to 0.55. In contrast, the entropy score of P2 decreases from E2=0.5 to 0.45. See also 490-492 in FIG. 4.

At 690-692 in FIG. 6, EDGE1 150 may update subset 622 based on the updated metric information. For example, this may involve selecting P11 from set 621 to replace P2 based on E11>E2, where E11=entropy score of P11 and E2=entropy score of P2. This way, subset 622 may be updated by adding a fast pattern with a relatively high entropy score and/or removing a fast pattern with a relatively low entropy score. Note that subset 622 may be updated every time the metric information is updated, or periodically at any suitable time interval. See also 495 in FIG. 4.

### Second Packet Flow

FIG. 7 is a schematic diagram illustrating second example 700 of intrusion detection with adaptive pattern selection for a second packet flow. In this example, consider a second packet flow between source=VM2 132 on host-A 110A located at first site 201 and destination 170 located on an external network (e.g., Internet). Implementation details discussed using FIG. 6 are also applicable here and will not be repeated for brevity.

At 710-720 in FIG. 7, in response to detecting a packet (see X2 710) belonging to a first packet flow between source=VM2 132 and destination endpoint 170, EDGE1 150 may perform fast pattern matching using subset 622 at rate=γ, or set 621 at rate=1−γ (discussed using in FIG. 6). Set 621 includes N=100 fast patterns while subset 622 includes of M=10 fast patterns. In the example in FIG. 7, set 621 will be used for fast pattern matching.

At 730-740 in FIG. 7, in response to determination that fast pattern matching matches X2 710 to fast pattern(s) in set 621, EDGE1 150 may add each matching fast pattern in a shortlist for slow-path matching. Otherwise (i.e., no match), EDGE1 150 may allow forwarding of the packet towards destination 170 and skipping slow-path matching. In the example in FIG. 7, multiple fast patterns in set 621 may be matched to X2 710, including fast pattern=P12 associated with first signature=S12, and second fast pattern=P13 associated with second signature=S13.

At 750 in FIG. 7, EDGE1 150 may perform slow-path matching to determine whether X2 710 is matchable to a signature associated with each matching fast pattern in the shortlist. Slow-path matching may involve identifying additional pattern(s) associated with the signature and determining whether the packet is matchable to the additional pattern(s) of shortlisted signatures=(S12, S13).

At 760-770 in FIG. 7, in response to determination that there is a matching signature based on the additional pattern(s), EDGE1 150 may perform any suitable remediation action(s), such as blocking or dropping X2 710, generating and sending an alert to a user (e.g., network administrator), generating log information, etc. Otherwise, at 775, EDGE1 150 may forward X2 710 towards destination endpoint 170.

At 780 in FIG. 7, EDGE1 150 may update the metric information associated matching fast patterns P12 and P13. Consider the case where E12=E13=0.45 based on (x=10, y=4.5) for both P12 and P13. Since P12 is a match during fast pattern matching and signature=S12 is a match during slow-path matching (i.e., both shortlisted and hit), E12 may be updated from 0.45 to (y+1)/(x+1)=5.5/11=0.5. In contrast, P13 is a match during fast pattern matching but signature=S13 is a not a match during slow-path matching (i.e., shortlisted but no hit), E13 may be updated from 0.5 to (y+0)/(x+1)=4.5/11=0.41. In other words, the entropy score of P12 increases from E1=0.45 to 0.5 while that of P13 decreases from E13=0.45 to 0.41.

At 790-792 in FIG. 7, EDGE1 150 may update subset 622 based on the updated metric information. For example, this may involve selecting P12 from set 621 to replace P9 based on E12>E9, where E12=entropy score of P12 and E9=entropy score of P9. This way, subset 622 may be updated by adding a fast pattern with a relatively high entropy score and/or removing a fast pattern with a relatively low entropy score. Again, subset 622 may be updated every time the metric information is updated, or periodically at any suitable time interval based on updated metric information. The above may be repeated for subsequent packets requiring intrusion detection.

### Container Implementation

Although discussed using VMs 131-136, it should be understood that intrusion detection with adaptive pattern selection may be performed for other virtualized computing instances, such as containers, etc. The term “container” (also known as “container instance”) is used generally to describe an application that is encapsulated with all its dependencies (e.g., binaries, libraries, etc.). For example, multiple containers may be executed as isolated processes inside VM1 131, where a different VNIC is configured for each container. Each container is “OS-less”, meaning that it does not include any OS that could weigh 11 s of Gigabytes (GB). This makes containers more lightweight, portable, efficient and suitable for delivery into an isolated OS environment. Running containers inside a VM (known as “containers-on-virtual-machine” approach) not only leverages the benefits of container technologies but also that of virtualization technologies.

### Computer System

The above examples can be implemented by hardware (including hardware logic circuitry), software or firmware or a combination thereof. The above examples may be implemented by any suitable computing device, computer system, etc. The computer system may include processor(s), memory unit(s) and physical NIC(s) that may communicate with each other via a communication bus, etc. The computer system may include a non-transitory computer-readable medium having stored thereon instructions or program code that, when executed by the processor, cause the processor to perform processes described herein with reference to FIG. 1 to FIG. 7. For example, a computer system capable of acting as EDGE 150/160 may be deployed in SDN environment 100 to perform examples of the present disclosure.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or any combination thereof.

Those skilled in the art will recognize that some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Software and/or to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. Those skilled in the art will understand that the units in the device in the examples can be arranged in the device in the examples as described or can be alternatively located in one or more devices different from that in the examples. The units in the examples described can be combined into one module or further divided into a plurality of sub-units.

1. A method for a computer system to perform intrusion detection with adaptive pattern selection, wherein the method comprises:
performing pattern selection by selecting a subset from a set of multiple patterns associated with respective multiple signatures for intrusion detection, wherein the subset is selected based on metric information associated with the multiple patterns;
in response to receiving a packet belonging to a flow between a source endpoint and a destination endpoint,
performing a first matching operation to determine whether the packet is matchable to a particular pattern from the set of multiple patterns or the subset;
in response to determination that the packet is matchable to the particular pattern, performing a second matching operation to determine whether the packet is matchable to a particular signature associated with the particular pattern;
updating metric information associated with the particular pattern based on the first matching operation or the second matching operation, or both; and
updating the subset based at least on the updated metric information associated with the particular pattern.

2. The method of claim 1, wherein updating the metric information comprises:
updating the metric information associated with the particular pattern in the form of an entropy score that is updated based on at least one of the following: (a) whether the first matching operation matches the packet to the particular pattern and shortlists the particular signature for the second matching operation; and (b) whether the second matching operation matches the packet to the particular signature.

3. The method of claim 1, wherein updating the subset comprises:
based on the updated metric information in the form of a reduced entropy score associated with the particular pattern, updating the subset by removing the particular pattern from the subset.

4. The method of claim 1, wherein updating the subset comprises:
based on the updated metric information in the form of an increased entropy score associated with the particular pattern that is not in the subset, updating the subset by adding the particular pattern to the subset.

5. The method of claim 1, wherein selecting the subset comprises:
selecting the subset from the set of multiple patterns in the form of multiple fast patterns identifiable from signature rule information associated with the respective multiple signatures.

6. The method of claim 1, wherein performing the second matching operation comprises:
identifying one or more additional patterns of the particular signature associated with the particular pattern; and
performing slow-path matching to determine whether the packet is matchable to the particular signature based on the one or more additional patterns.

7. The method of claim 1, wherein the method further comprises:
in response to determination that the packet is matchable to the particular signature during the second matching operation, performing a remediation action that includes at least one of the following: (a) blocking forwarding of the packet towards the destination endpoint, (b) sending an alert to a user and (c) generate log information;
otherwise, allowing forwarding of the packet towards the destination endpoint.

8. A non-transitory computer-readable storage medium that includes a set of instructions which, in response to execution by a processor of a computer system, cause the processor to perform intrusion detection with adaptive pattern selection, wherein the method comprises:
performing pattern selection by selecting a subset from a set of multiple patterns associated with respective multiple signatures for intrusion detection, wherein the subset is selected based on metric information associated with the multiple patterns;
in response to receiving a packet belonging to a flow between a source endpoint and a destination endpoint,
performing a first matching operation to determine whether the packet is matchable to a particular pattern from the set of multiple patterns or the subset;
in response to determination that the packet is matchable to the particular pattern, performing a second matching operation to determine whether the packet is matchable to a particular signature associated with the particular pattern;
updating metric information associated with the particular pattern based on the first matching operation or the second matching operation, or both; and
updating the subset based at least on the updated metric information associated with the particular pattern.

9. The non-transitory computer-readable storage medium of claim 8, wherein updating the metric information comprises:
updating the metric information associated with the particular pattern in the form of an entropy score that is updated based on at least one of the following: (a) whether the first matching operation matches the packet to the particular pattern and shortlists the particular signature for the second matching operation; and (b) whether the second matching operation matches the packet to the particular signature.

10. The non-transitory computer-readable storage medium of claim 8, wherein updating the subset comprises:
based on the updated metric information in the form of a reduced entropy score associated with the particular pattern, updating the subset by removing the particular pattern from the subset.

11. The non-transitory computer-readable storage medium of claim 8, wherein updating the subset comprises:
based on the updated metric information in the form of an increased entropy score associated with the particular pattern that is not in the subset, updating the subset by adding the particular pattern to the subset.

12. The non-transitory computer-readable storage medium of claim 8, wherein selecting the subset comprises:
selecting the subset from the set of multiple patterns in the form of multiple fast patterns identifiable from signature rule information associated with the respective multiple signatures.

13. The non-transitory computer-readable storage medium of claim 8, wherein performing the second matching operation comprises:
identifying one or more additional patterns of the particular signature associated with the particular pattern; and
performing slow-path matching to determine whether the packet is matchable to the particular signature based on the one or more additional patterns.

14. The non-transitory computer-readable storage medium of claim 8, wherein the method further comprises:
in response to determination that the packet is matchable to the particular signature during the second matching operation, performing a remediation action that includes at least one of the following: (a) blocking forwarding of the packet towards the destination endpoint, (b) sending an alert to a user and (c) generate log information;
otherwise, allowing forwarding of the packet towards the destination endpoint.

15. A computer system, comprising:
a datastore to store a set of multiple patterns; and
an intrusion detection system (IDS) engine to perform the following:
perform pattern selection by selecting a subset from a set of multiple patterns associated with respective multiple signatures for intrusion detection, wherein the subset is selected based on metric information associated with the multiple patterns;
in response to receiving a packet belonging to a flow between a source endpoint and a destination endpoint,
perform a first matching operation to determine whether the packet is matchable to a particular pattern from the set of multiple patterns or the subset;
in response to determination that the packet is matchable to the particular pattern, perform a second matching operation to determine whether the packet is matchable to a particular signature associated with the particular pattern;
update metric information associated with the particular pattern based on the first matching operation or the second matching operation, or both; and
update the subset based at least on the updated metric information associated with the particular pattern.

16. The computer system of claim 15, wherein the IDS engine is to update the metric information by performing the following:
update the metric information associated with the particular pattern in the form of an entropy score that is updated based on at least one of the following: (a) whether the first matching operation matches the packet to the particular pattern and shortlists the particular signature for the second matching operation; and (b) whether the second matching operation matches the packet to the particular signature.

17. The computer system of claim 15, wherein the IDS engine is to update the subset by performing the following:
based on the updated metric information in the form of a reduced entropy score associated with the particular pattern, update the subset by removing the particular pattern from the subset.

18. The computer system of claim 15, wherein the IDS engine is to update the subset by performing the following:
based on the updated metric information in the form of an increased entropy score associated with the particular pattern that is not in the subset, update the subset by adding the particular pattern to the subset.

19. The computer system of claim 15, wherein the IDS engine is to select the subset by performing the following:
select the subset from the set of multiple patterns in the form of multiple fast patterns identifiable from signature rule information associated with the respective multiple signatures.

20. The computer system of claim 15, wherein the IDS engine is to perform the second matching operation by performing the following:
identify one or more additional patterns of the particular signature associated with the particular pattern; and
perform slow-path matching to determine whether the packet is matchable to the particular signature based on the one or more additional patterns.

21. The computer system of claim 15, wherein the IDS engine is further to perform the following:
in response to determination that the packet is matchable to the particular signature during the second matching operation, perform a remediation action that includes at least one of the following: (a) blocking forwarding of the packet towards the destination endpoint, (b) sending an alert to a user and (c) generate log information;
otherwise, allow forwarding of the packet towards the destination endpoint.
